(19) United States
(12) Patent Application Publication
(10) Pub. No.: US 2021/0040255 A1
(43) Pub. Date: Feb. 11, 2021

(54) PRODUCTION PROCESS FOR POLYETHER ESTER ELASTOMERS

(71) Applicant: BASF SE, Ludwigshafen am Rhein (DE)

(72) Inventors: Frank PRISSOK, Lemfoerde (DE); Elmar POESELT, Lemfoerde (DE); Martina SCHOEMER, Ludwigshafen (DE); Florian PUCH, Ludwigshafen (DE); Dirk KEMPFERT, Lemfoerde (DE)

(73) Assignee: BASF SE, Ludwigshafen am Rhein (DE)

(21) Appl. No.: 16/979,740

(22) PCT Filed: Mar. 14, 2019
(86) PCT No.: PCT/EP2019/056423

§ 371 Date: Sep. 10, 2020

(30) Foreign Application Priority Data
Mar. 14, 2018 (EP) 18161735.8

(51) Int. Cl. C08F 293/00

(52) U.S. Cl. CPC C08F 293/00

(57) ABSTRACT

A process for producing a block copolymer may involve reacting at least one aromatic polyester having a melting point in the range from 160 to 350° C. with at least one second compound selected from diamines and diols at temperatures greater than 160° C. to obtain a mixture; and heating the mixture at a temperature in the range from 100° C. to 300° C. for from 1 to 240 hours to obtain a block copolymer, wherein in the reacting, the second compound is employed in an amount of 0.02 to 0.3 mol per mol of ester bond in the polyester. Block copolymers may be obtained by such a process and used for producing extruded, injection molded and pressed articles and also foams, foam particles, shoe soles, cable sheaths, hoses, profiles, drive belts, fibers, nonwovens, films, moldings, plugs, housings, damping elements for the electronic/automotive industry, mechanical engineering, 3-D printing, medicine, or consumer goods.

The present invention relates to a process for producing a block copolymer comprising the reaction of at least one aromatic polyester having a melting point in the range from 160° C. to 350° C. with at least one compound selected from the group consisting of diamines and diols at a temperature of greater than 160° C. to obtain a mixture (G-a); and the heat treatment of the mixture (G-a) at a temperature in the range from 100° C. to 300° C. for a time in the range from 4 to 240 hours to obtain a block copolymer, wherein in step (a) the compound selected from the group consisting of diamines and diols is employed in an amount of 0.02 to 0.3 mol per mol of ester bond in the polyester. The present invention further relates to block copolymers obtained or obtainable by such a process and to the use of such block copolymers for producing extruded, injection molded and pressed articles and also foams, foam particles, shoe soles, cable sheaths, hoses, profiles, drive belts, fibers, nonwovens, films, moldings, plugs, housings, damping elements for the electricals industry, automotive industry, mechanical engineering, 3-D printing, medicine and consumer goods.

Polymers based on thermoplastic elastomers (TPE) are employed in various fields. Depending on the application the properties of the polymer may be modified.

EP 0 656 397 A1 discloses triblock polyaddition products comprising TPU blocks and polyester blocks which consist of two hard phase blocks, namely the polyester hard phase and the TPU hard phase, consisting of the urethane hard segment, the oligomeric or polymeric reaction product of an organic diisocyanate and a low molecular weight chain extender, preferably an alkanediol and/or dialkylene glycol and the elastic urethane soft segment, consisting of the higher molecular weight polyhydroxyl compound, preferably a higher molecular weight polyesterdiol and/or polyetherdiol, which are chemically interlinked in blockwise fashion by urethane and/or amide bonds. The urethane or amide bonds are formed from terminal hydroxyl or carboxyl groups of the polyesters and from terminal isocyanate groups of the TPU. The reaction products may also comprise further bonds, for example urea bonds, allophanates, isocyanurates and biurets.

EP 1 693 394 A1 discloses thermoplastic polyurethanes comprising polyester blocks and processes for the production thereof. Thermoplastic polyesters are converted with a diol and the thus obtained reaction product is then reacted with isocyanates. In the processes known from the prior art it is often difficult to adjust the block lengths and thus the properties of the obtained polymer.

It is accordingly an object of the present invention to provide a polymer and a process for producing a polymer in which the block structure and thus the desired properties of the polymer may be easily adjusted. It is a further object of the present invention to provide a process for cost-effective production of the corresponding polymers.

This object is achieved in accordance with the invention by a process for producing a block copolymer comprising the steps of
(a) reaction of at least one aromatic polyester having a melting point in the range from 160° C. to 350° C. with at least one compound selected from the group consisting of diamines and diols at a temperature of greater than 160° C. to obtain a mixture (G-a);
(b) heat treatment of the mixture (G-a) at a temperature in the range from 100° C. to 300° C. for a time in the range from 1 to 240 hours to obtain a block copolymer,
   wherein in step (a) the compound selected from the group consisting of diamines and diols is employed in an amount in the range from 0.02 to 0.3 mol per mol of ester bond in the polyester.

It has been found that, surprisingly, the process according to the invention makes it possible to obtain block copolymers having advantageous profiles of properties. After a molecular weight decrease in step (a) of the process according to the invention the heat treatment under the conditions according to the invention in step (b) surprisingly effects a molecular weight increase.

In the context of the invention a block copolymer is to be understood as meaning a polymer composed of repeating blocks, for example of two repeating blocks.

The process according to the invention comprises the steps (a) and (b). According to step (a) at least one aromatic polyester having a melting point in the range from 160° C. to 350° C. is reacted with at least one compound selected from the group consisting of diamines and diols at a temperature of greater than 160° C. to obtain a mixture (G-a), wherein the compound selected from the group consisting of diamines and diols is employed in an amount in the range from 0.02 to 0.3 mol per mol of ester bond in the polyester. In the context of the present invention it is preferable when the diols and diamines are polymeric compounds. According to the invention the reaction is carried out at a temperature of greater than 160° C., in particular of greater than 200° C. According to the invention the temperature during the reaction according to step (a) is greater than the melting point of the employed polyester.

According to the invention the amount of the compounds employed in step (a) is preferably chosen such that the molar amount of the employed amine and hydroxyl groups based on the amount of the ester bonds in the polyester is in the range from 1:3 to 1:50, more preferably in the range from 1:5 to 1:20, particularly preferably in the range from 1:8 to 1:12. Accordingly the compound selected from the group consisting of diamines and diols is employed for example in an amount in the range from 0.05 to 0.2 mol per mol of ester bond in the polyester, more preferably in an amount in the range from 0.1 to 0.15 mol per mol of ester bond in the polyester.

In the context of the present invention the melting points/melting ranges are determined by DSC on predried samples unless otherwise stated. Unless otherwise stated the DSC measurement is performed at a heating rate of 20° C./min in a temperature range of 70° C. to 250° C. The holding time at 250° C. is 2 minutes, the cooling rate in the cooling run is 20° C./min unless otherwise stated.

According to the invention the reaction according to step (a) is carried out at a temperature of greater than 160° C. and a mixture (G-a) is obtained. According to step (b) of the process according to the invention mixture (G-a) is heat-treated at a temperature in the range from 100° C. to 300° C. for a time in the range from 1 to 240 hours to obtain a block copolymer. In the context of the present invention the temperature during the treatment according to step (b) is less than the melting temperature of the mixture G-a or of the obtained block copolymer.

In the context of the present invention the reaction according to step (a) is a transesterification, preferably a transesterification in the melt, provided that an OH-functionalized compound is employed. In the context of the present invention the heat treatment according to step (b) of the process according to the invention is for example a crystallization, a post-crystallization or a solid-state reaction such as a solid-state polymerization/polycondensation in the solid phase. According to the invention step (b) of the process according to the invention is performed at a temperature below the melting temperature of the obtained mixture (G-a).

The process according to the invention produces block copolymers from a polyester having a high melting point and a diol or diamine. The biphasic block copolymer obtained according to the invention typically comprises crystalline ester blocks and amorphous blocks, in particular amorphous polyol blocks, coupled via amide, ester and/or urethane bonds, or else semicrystalline blocks.

An important prerequisite for a mechanically and chemically stable block copolymer having good heat stability is not only clear phase separation but also sufficient block size of the hard and soft phases which ensure a broad temperature range for the application. This application range may be detected by means of DMA (temperature range between glass transition of the soft phase and first softening of the hard phase).

The reaction according to step (a) is preferably carried out in continuous fashion. In a further embodiment the present invention accordingly relates to a process for producing a block copolymer as described hereinabove, wherein the reaction according to step (a) is carried out in continuous fashion.

According to step (a) the reaction is carried out at a temperature above 160° C. According to the invention the reaction may be carried out in a suitable apparatus, suitable processes being known per se to those skilled in the art. According to the invention it is also possible for additives or assistants to be employed to accelerate/to improve the reaction according to step (a). In particular, catalysts may be employed.

Suitable catalysts for the reaction according to step (a) are for example tributyltin oxide, tin(II) dioctoate, dibutyltin dilaurate or Bi(III) carboxylate.

In particular, the reaction according to step (a) may be carried out in an extruder. It is likewise possible according to the invention for the reaction according to step (a) to be carried out in a kneader. The reaction according to step (b) may typically be carried out in a solid phase reactor, for example a vacuum oven or tumble reactor.

The reaction according to step (a) may be effected for example at a temperature in the range from 160° C. to 350° C., preferably in the range from 220° C. to 300° C. and in particular from 220° C. to 280° C., more preferably from 230° C. to 260° C., and for example with a residence time of 1 second to 15 minutes, preferably with a residence time of 2 seconds to 10 minutes, more preferably with a residence time of 5 seconds to 5 minutes or with a residence time of 10 seconds to 1 minute in for example a flowable, softened or preferably molten state of the polyester and the polymeric diol, in particular by stirring, rolling, kneading or preferably extruding, for example using customary plasticizing apparatuses, for example mills, kneaders or extruders, preferably in an extruder.

In a further embodiment the present invention accordingly relates to a process for producing a block copolymer as described hereinabove, wherein the reaction according to step (a) is carried out in a stirred tank, reactor, extruder or a kneader.

The process according to the invention may comprise further steps, for example temperature adjustments or shaping steps.

According to the invention the heat treatment according to step (b) is carried out at a temperature in the range from 100° C. to 300° C., preferably in the range from 150° C. to 200° C. and in particular from 160° C. to 200° C. It is preferable when the solid phase condensation is carried out below the crystallization temperature of the obtained polymer. According to step (b) of the process according to the invention the heat treatment is carried out for a duration in the range from 1 to 240 hours, preferably for a duration in the range from 4 to 120 hours, more preferably for a duration in the range from 8 to 48 hours. In a further embodiment of the present invention the heat treatment is carried out for a duration in the range from 1 to 48 hours or else for a duration in the range from 1 to 24 hours.

In a further embodiment the present invention also relates to a process for producing a block copolymer as described hereinabove, wherein the reaction according to step (b) is carried out in a stirred tank, reactor, extruder or a kneader.

The aromatic polyesters employed according to the invention have a melting point in the range from 160° C. to 350° C., preferably a melting point of greater than 180° C. More preferably the polyesters suitable in accordance with the invention have a melting point of greater than 200° C., particularly preferably a melting point of greater than 220° C. Accordingly, the polyesters suitable in accordance with the invention particularly preferably have a melting point in the range from 220° C. to 350° C.

Polyesters suitable in accordance with the invention are known per se and comprise at least one aromatic ring bound in the polycondensate main chain which is derived from an aromatic dicarboxylic acid. The aromatic ring may optionally also be substituted, for example by halogen atoms, for example chlorine or bromine, and/or by linear or branched alkyl groups having preferably 1 to 4 carbon atoms, in particular 1 to 2 carbon atoms, for example a methyl, ethyl, isopropyl or n-propyl group and/or an n-butyl, isobutyl or tert-butyl group. The polyesters may be produced by polycondensation of aromatic dicarboxylic acids or mixtures of aromatic and aliphatic and/or cycloaliphatic dicarboxylic acids and also the corresponding ester-forming derivatives, for example dicarboxylic anhydrides, mono- and/or diesters having advantageously not more than 4 carbon atoms in the alcohol radical, with aliphatic dihydroxyl compounds at elevated temperatures, for example of 160° C. to 260° C., in the presence or absence of esterification catalysts.

Suitable in accordance with the invention are in particular aromatic dicarboxylic acids, for example naphthalene dicarboxylic acids, isophthalic acid and in particular terephthalic acid or mixtures of these dicarboxylic acids. When mixtures of aromatic and (cyclo)aliphatic dicarboxylic acids are employed up to 10 mol % of the aromatic dicarboxylic acids may be replaced by aliphatic and/or cycloaliphatic dicarboxylic acids having advantageously 4 to 14 carbon atoms, for example succinic, adipic, azelaic, sebacic, dodecanedioic and/or cyclohexanedicarboxylic acid.

Contemplated aliphatic dihydroxyl compounds are preferably alkanediols having 2 to 6 carbon atoms and cycloalkanediols having 5 to 7 carbon atoms. Recited by way of example and preferably employed are 1,2-ethanediol, 1,4-butanediol, 1,6-hexanediol, neopentyl glycol and 1,4-cyclohexanediol or mixtures of at least two of the recited diols.

Polyesters that have proven exceptionally suitable include specifically the polyalkylene terephthalates of alkanediols having 2 to 6 carbon atoms, in particular aromatic polyesters selected from the group consisting of polybutylene terephthalate (PBT), polyethylene terephthalate (PET) and polyethylene naphtalate (PEN), so that preferably polyethylene terephthalate and especially preferably polybutylene terephthalate or mixtures of polyethylene terephthalate and polybutylene terephthalate find use.

In a further embodiment the present invention accordingly relates to a process for producing a block copolymer as described hereinabove, wherein the aromatic polyester is selected from the group consisting of polybutylene terephthalate (PBT), polyethylene terephthalate (PET) and polyethylene naphthalate (PEN). In a further embodiment the present invention accordingly relates to a process for producing a block copolymer as described hereinabove, wherein the aromatic polyester is polybutylene terephthalate (PBT).

According to the invention suitable molecular weight ranges (Mn) of the employed polyester are in the range from 2000 to 100 000, particularly preferably in the range from 10 000 to 50 000.

Unless otherwise stated in the context of the present invention the determination of the weight-average molecular weights Mw of the thermoplastic block copolymers is carried out dissolved in HFIP (hexafluoroisopropanol) by GPC. Determination of the molecular weight is carried out using two GPC columns arranged in series (PSS-Gel; 100A; 5μ; 300*8 mm, Jordi-Gel DVB; MixedBed; 5μ; 250*10 mm; column temperature 60° C.; flow 1 mL/min; RI detector). Calibration is performed with polymethyl methacrylate (EasyCal; from PSS, Mainz) and HFIP is used as eluent.

According to step (a) the polyester is reacted with at least one compound selected from the group consisting of diamines and diols to obtain the mixture (G-a). Suitable diamines and diols are known per se to those skilled in the art. According to the invention low molecular weight or else oligomeric and polymeric diols and diamines may be employed. For example the average molecular weight Mn of the employed diamine or diol may be in the range from 200 to 2000 g/mol.

In a further embodiment the present invention accordingly relates to a process for producing a block copolymer as described hereinabove, wherein the compound selected from the group consisting of diamines and diols has an average molecular weight Mn in the range from 200 to 2000 g/mol. It is more preferable in the context of the present invention to employ a diol having an average molecular weight Mn in the range from 200 to 2000 g/mol. Also employable according to the invention are mixtures of different diols or different diamines.

Suitable diols and diamines having an average molecular weight Mn in the range from 200 to 2000 g/mol are known per se to those skilled in the art. Polymeric diamines or polymeric diols for example are suitable in the context of the present invention.

In a further embodiment the present invention accordingly relates to a process for producing a block copolymer as described hereinabove, wherein the compound selected from the group consisting of diamines and diols is a polymeric diamine or a polymeric diol.

Suitable polymeric diols are for example selected from the group consisting of polyetherols, polyesterols, polycarbonate alcohols, hybrid polyols and polysiloxanes.

Polyols are known in principle to those skilled in the art and described for example in “Kunststoffhandbuch [Plastics Handbook], volume 7, Polyurethane”, Carl Hanser Verlag, 3rd edition 1993, chapter 3.1. Particular preference is given to using polyesterols or polyetherols as polyols. Particular preference is given to polyeter polyols. The number-average molecular weight of the polyols employed according to the invention is preferably between 200 and 2000 g/mol, for example between 250 g/mol and 2000 g/mol, preferably between 500 g/mol and 1500 g/mol, in particular between 650 g/mol and 1000 g/mol.

According to the invention preferred polyetherols are polyethylene glycols, polypropylene glycols and polytetrahydrofurans and also mixed polyetherols thereof. Mixtures of different polytetrahydrofurans differing in molecular weight may also be employed according to the invention for example.

In a further embodiment the present invention accordingly relates to a process for producing a block copolymer as described hereinabove, wherein the compound selected from the group consisting of diamines and diols is a polytetrahydrofuran.

In a particularly preferred embodiment, the polymeric diol is a polytetrahydrofuran (PTHF) having a molecular weight Mn in the range from 200 g/mol to 2000 g/mol, more preferably in the range from 250 g/mol to 1500 g/mol, more preferably in the range from 500 g/mol to 1000 g/mol.

According to the invention not only PTHF but also other further polyethers are suitable, or else polyesters.

In a further embodiment the present invention accordingly relates to a process for producing a block copolymer as described hereinabove, wherein the polymeric diol is a polyetherdiol. In a further embodiment the present invention accordingly relates to a process for producing a block copolymer as described hereinabove, wherein the compound selected from the group consisting of diamines and diols is a polyether diol.

In another embodiment the present invention also relates to a process According to the invention the polyol may be employed in pure form or in the form of a composition containing the polyol and at least one solvent. Suitable solvents are known per se to those skilled in the art.

According to step (a) a mixture (G-a) is obtained which may comprise not only the reaction product but also unconverted polyester or unconverted polymeric diol. The reaction product is thus present as a mixture according to the invention, wherein the individual molecules may differ for example in terms of distribution and the length of the polyester blocks.

It has been found that, surprisingly, the inventive combination of the steps (a) and (b) according to step (b) of the process according to the invention results in a molecular weight increase, thus allowing block copolymers having a good profile of properties to be obtained with the process according to the invention. The block copolymers obtained with the process according to the invention have a good thermal stability for example.

The process according to the invention may comprise further steps but the process according to the invention preferably does not comprise a reaction of the mixture (G-a) with an isocyanate.

In a further aspect the present invention also relates to a block copolymer obtained or obtainable by a process according to the invention.

The block copolymers according to the invention typically comprise a hard phase of aromatic polyester and a soft phase.

On account of their predetermined block structure which results from their construction from molecules which are per se already polymeric and thus long-chained in nature such as a polytetrahydrofuran building block and a polybutylene terephthalate building block, the block copolymers according to the invention exhibit a good phase separation between the elastic soft phase and the stiff hard phase. This good phase separation manifests in a property which is referred to as high “snapback” but is characterizable by physical methods only with difficulty.

The processing of the obtained block copolymers may be effected according to customary processes, for example in extruders, injection molding machines, blow molds, calenders, kneaders and presses.

On account of the good mechanical properties and the good temperature behavior the block copolymers according to the invention are suitable in particular for producing extruded, injection molded and pressed articles and also foams, foam particles, shoes soles, cable sheaths, hoses, profiles, drive belts, fibers, nonwovens, films, moldings, plugs, housings, damping elements for the electricals industry, automotive industry, mechanical engineering, 3-D printing, medicine and consumer goods.

In a further aspect the present invention further relates to the use of a block copolymer according to the invention or of a block copolymer obtained or obtainable by a process according to the invention for producing extruded, injection molded and pressed articles and also foams, foam particles, shoe soles, cable sheaths, hoses, profiles, drive belts, fibers, nonwovens, films, moldings, plugs, housings, damping elements for the electricals industry, automotive industry, mechanical engineering, 3-D printing, medicine and consumer goods.

Further embodiments of the present invention are apparent from the claims and the examples. It will be appreciated that the features of the subject matter/processes/uses according to the invention that are recited hereinabove and elucidated hereinbelow are usable not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

Exemplary embodiments of the present invention are specified hereinbelow but these are not intended to restrict the present invention. In particular the present invention also encompasses those embodiments that result from the dependency references and hence combinations that are specified hereinbelow.
1. Process for producing a block copolymer comprising the steps of
   (a) reaction of at least one aromatic polyester having a melting point in the range from 160° C. to 350° C. with at least one compound selected from the group consisting of diamines and diols at a temperature of greater than 160° C. to obtain a mixture (G-a);
   (b) heat treatment of the mixture (G-a) at a temperature in the range from 100° C. to 300° C. for a time in the range from 1 to 240 hours to obtain a block copolymer,
wherein in step (a) the compound selected from the group consisting of diamines and diols is employed in an amount of 0.02 to 0.3 mol per mol of ester bond in the polyester.
2. Process according to embodiment 1, wherein the reaction according to step (a) is carried out in continuous fashion.
3. Process according to embodiment 1 or 2, wherein the reaction according to step (a) is carried out in a stirred tank, reactor, extruder or kneader.
4. Process according to any of embodiments 1 to 3, wherein the compound selected from the group consisting of diamines and diols has an average molecular weight Mn in the range from 200 to 2000 g/mol.
5. Process according to any of embodiments 1 to 4, wherein the aromatic polyester is selected from the group consisting of polybutylene terephthalate (PBT), polyethylene terephthalate (PET) and polyethylene naphthalate (PEN).
6. Process according to any of embodiments 1 to 5, wherein the compound selected from the group consisting of diamines and diols is a polymeric diamine or a polymeric diol.
7. Process according to any of embodiments 1 to 6, wherein the compound selected from the group consisting of diamines and diols is a polyether diol.
8. Process according to any of embodiments 1 to 7, wherein the compound selected from the group consisting of diamines and diols is a polytetrahydrofuran.
9. Process for producing a block copolymer comprising the steps of
   (a) reaction of at least one aromatic polyester having a melting point in the range from 160° C. to 350° C. with at least one compound selected from the group consisting of diamines and diols at a temperature of greater than 200° C. to obtain a mixture (G-a);
   (b) heat treatment of the mixture (G-a) at a temperature in the range from 100° C. to 300° C. for a time in the range from 1 to 240 hours to obtain a block copolymer,
wherein in step (a) the compound selected from the group consisting of diamines and diols is employed in an amount of 0.02 to 0.3 mol per mol of ester bond in the polyester.
10. Process according to embodiment 9, wherein the reaction according to step (a) is carried out in continuous fashion.
11. Process according to embodiment 9 or 10, wherein the reaction according to step (a) is carried out in a stirred tank, reactor, extruder or kneader.
12. Process according to any of embodiments 9 to 11, wherein the compound selected from the group consisting of diamines and diols has an average molecular weight Mn in the range from 200 to 2000 g/mol.
13. Process according to any of embodiments 9 to 12, wherein the aromatic polyester is selected from the group consisting of polybutylene terephthalate (PBT), polyethylene terephthalate (PET) and polyethylene naphthalate (PEN).
14. Process according to any of embodiments 9 to 13, wherein the compound selected from the group consisting of diamines and diols is a polymeric diamine or a polymeric diol.
15. Process according to any of embodiments 9 to 14, wherein the compound selected from the group consisting of diamines and diols is a polyether diol.
16. Process according to any of embodiments 9 to 15, wherein the compound selected from the group consisting of diamines and diols is a polytetrahydrofuran.
17. Block copolymer obtained or obtainable by a process according to any of embodiments 1 to 16.
18. Block copolymer obtained or obtainable by a process for producing a block copolymer comprising the steps of
   (a) reaction of at least one aromatic polyester having a melting point in the range from 160° C. to 350° C. with at least one compound selected from the group consisting of diamines and diols at a temperature of greater than 160° C. to obtain a mixture (G-a);
   (b) heat treatment of the mixture (G-a) at a temperature in the range from 100° C. to 300° C. for a time in the range from 1 to 240 hours to obtain a block copolymer,
wherein in step (a) the compound selected from the group consisting of diamines and diols is employed in an amount of 0.02 to 0.3 mol per mol of ester bond in the polyester.
19. Block copolymer obtained or obtainable by a process for producing a block copolymer comprising the steps of
   (a) reaction of at least one aromatic polyester having a melting point in the range from 160° C. to 350° C. with at least one compound selected from the group consisting of diamines and diols at a temperature of greater than 200° C. to obtain a mixture (G-a);
   (b) heat treatment of the mixture (G-a) at a temperature in the range from 100° C. to 300° C. for a time in the range from 1 to 240 hours to obtain a block copolymer, wherein in step (a) the compound selected from the group consisting of diamines and diols is employed in an amount of 0.02 to 0.3 mol per mol of ester bond in the polyester.
20. Block copolymer according to embodiment 18 or 19, wherein the reaction according to step (a) is carried out in continuous fashion.
21. Block copolymer according to any of embodiments 18 to 20, wherein the reaction according to step (a) is carried out in a stirred tank, reactor, extruder or kneader.
22. Block copolymer according to any of embodiments 18 to 21, wherein the compound selected from the group consisting of diamines and diols has an average molecular weight Mn in the range from 200 to 2000 g/mol.
23. Block copolymer according to any of embodiments 18 to 22, wherein the aromatic polyester is selected from the group consisting of polybutylene terephthalate (PBT), polyethylene terephthalate (PET) and polyethylene naphthalate (PEN).
24. Block copolymer according to any of embodiments 18 to 23, wherein the compound selected from the group consisting of diamines and diols is a polymeric diamine or a polymeric diol.
25. Block copolymer according to any of embodiments 18 to 24, wherein the compound selected from the group consisting of diamines and diols is a polyether diol.
26. Block copolymer according to any of embodiments 18 to 25, wherein the compound selected from the group consisting of diamines and diols is a polytetrahydrofuran.
27. Use of a block copolymer according to any of embodiments 17 to 26 or of a block copolymer obtained or obtainable by a process according to any of embodiments 1 to 16 for producing extruded, injection molded and pressed articles and also foams, foam particles, shoe soles, cable sheaths, hoses, profiles, drive belts, fibers, nonwovens, films, moldings, plugs, housings, damping elements for the electricals industry, automotive industry, mechanical engineering, 3-D printing, medicine and consumer goods.

The examples which follow are intended to illustrate the invention but are in no way intended to restrict the subject matter of the present invention.

### EXAMPLES

1. The following input materials were employed:
Polyol 1: Polybutylene terephthalate (PBT) having a weight-average molecular weight of 60 000 g/mol
Polyol 2: Polyether polyol having an OH number of 453.4, a weight-average molecular weight of 248 g/mol and exclusively primary OH groups (based on tetramethylene oxide, functionality: 2)
Polyol 3: Polyether polyol having an OH number of 112.2, a weight-average molecular weight of 1000 g/mol and exclusively primary OH groups (based on tetramethylene oxide, functionality: 2)

2. Reaction and Heat Treatment Example

A polyester (polyol 1) is melted in a DSM mini extruder at 260° C. and reacted with a further polyol for 10 minutes (polyol 2 or 3) (table 1). The mixture is discharged and subsequently heat-treated under a nitrogen atmosphere in an oven at 170° C. for 32 h.

TABLE 1
Synthesis examples

| | Example 1 | Example 2 |
|---|---|---|
| Polyol 1 (g) | 10.2 | 10.2 |
| Polyol 2 (g) | 1.2 | |
| Polyol 3 (g) | | 4.9 |

After the heat treatment the molecular weight was determined by gel permeation chromatography. The obtained number- and weight-average molecular weights and the polydispersity after the reaction and after the heat treatment are reported in table 2.

TABLE 2
Number- and weight-average molecular weight
after reaction and after heat treatment

| | Number-average | Weight-average | |
|---|---|---|---|
| | molecular weight | molecular weight | Polydispersity |
| | Mₙ (g/mol) | M_{w} (g/mol) | M_{w}/Mₙ (—) |
| Example 1 after | 4380 | 9400 | 2.1 |
| reaction | | | |
| Example 1 after | 9050 | 24 900 | 2.8 |
| heat treatment | | | |
| Example 2 after | 5680 | 12 900 | 2.3 |
| reaction | | | |
| Example 2 after | 12 500 | 36 200 | 2.9 |
| heat treatment | | | |

3. Measurement Method

The gel permeation chromatography was performed in hexafluorisopropanol +0.05% tri-fluoroacetic acid potassium salt. Calibration was performed with narrowly distributed PMMA standards having molecular weights of M=800 to M=2 200 000.

### CITED LITERATURE

EP 0 656 397 A1

EP 1 693 394 A1

Kunststoffhandbuch, volume 7, Polyurethane, Carl Hanser Verlag, 3rd edition, 1993, chapter 3.1

1. A process for producing a block copolymer, the process comprising:
(a) reacting a first compound comprising an aromatic polyester having a melting point in range of from 160° C. to 350° C. with second compound comprising a diamine and/or diol at a temperature of greater than 160° C. to obtain a mixture;
(b) heating the mixture at a temperature in range of from 100° C. to 300° C. for a time in range of from 1 to 240 hours to obtain a block copolymer,
wherein, in the reacting (a), the second compound is employed in range of from 0.02 to 0.3 mol per mol of ester bond in the aromatic polyester.

2. The process of claim 1, wherein the reacting (a) is continuous.

3. The process of claim 1, wherein the reacting (a) is carried out in a stirred tank, reactor, extruder, or kneader.

4. The process of claim 1, wherein the second compound has an average molecular weight Mn in range of from 200 to 2000 g/mol.

5. The process of claim 1, wherein the aromatic polyester is selected from the group consisting of polybutylene terephthalate, polyethylene terephthalate, and polyethylene naphthalate.

6. The process of claim 1, wherein the second compound is a polymeric diamine.

7. The process of claim 1, wherein the second compound is a polyether diol.

8. The process of claim 1, wherein the second compound is a polytetrahydrofuran.

9. A block copolymer, obtained by the process of claim 1.

10. A process of producing an article including extruded, injection molded, pressed article, foam, foam particle, shoe sole, cable sheath, hose, profile, drive belt, fiber, nonwoven, film, molding, plug, housing, or damping element, the process comprising:
carrying out the method of claim 1; and
optionally, further processing to form the article.

11. The process of claim 1, wherein the aromatic polyester comprises polyethylene terephthalate.

12. The process of claim 1, wherein the aromatic polyester comprises polyethylene naphthalate.

13. The process of claim 1, wherein the aromatic polyester comprises polybutylene terephthalate.

14. The process of claim 1, wherein the second compound is a polymeric diol.

15. The process of claim 5, wherein the second compound is a polyether diol.

16. The process of claim 5, wherein the second compound is a polytetrahydrofuran.

17. The process of claim 1, wherein the melting point of the aromatic polyester is at least 200° C.

18. The process of claim 1, wherein the heating (b) is in a range of from 220 to 300° C.
